(19) United States
(12) Patent Application Publication
(10) Pub. No.: US 2023/0195119 A1
(43) Pub. Date: Jun. 22, 2023

(54) SYSTEMS AND METHODS FOR CONTROLLING AUTONOMOUS MOBILE ROBOTS IN A MANUFACTURING ENVIRONMENT

(71) Applicant: Ford Global Technologies, LLC, Dearborn, MI (US)

(72) Inventors: Geoffrey Horowitz, Birmingham, MI (US); Gregory P. Linkowski, Dearborn, MI (US); Meghna Menon, Rochester Hills, MI (US); Sarah Garrow, Detroit, MI (US); Yifan Chen, Ann Arbor, MI (US)

(73) Assignee: Ford Global Technologies, LLC, Dearborn, MI (US)

(21) Appl. No.: 17/559,268

(22) Filed: Dec. 22, 2021

(51) Int. Cl. G05D 1/02

(52) U.S. Cl. CPC G05D 1/0212; G05D 1/0274; G05D 1/0287; G05D 2201/0216

(57) ABSTRACT

A method includes identifying a set of intermediate grids of a grid map of the manufacturing environment based on a location of the first AMR and a destination grid of the grid map and appending temporal information to the set of intermediate grids based on a mobility characteristic of the first AMR. The method includes generating a first reservation based on the set of intermediate grids and the temporal information of the set of intermediate grids, determining a state of the first reservation based on priority information associated with the plurality of AMRs and one or more additional reservations associated with the one or more additional AMRs from among the plurality of AMRs, and assigning the first reservation to the first AMR in response to the first reservation being in an available state.

### FIELD

The present disclosure relates to systems and methods for controlling autonomous mobile robots in a manufacturing environment.

### BACKGROUND

The statements in this section merely provide background information related to the present disclosure and may not constitute prior art.

A manufacturing environment can include one or more mobile robots that perform various automated tasks, such as moving materials and tools within the manufacturing environment. The mobile robots may autonomously travel along a defined path to various locations within the manufacturing environment to perform the various automated tasks. However, the defined paths of the mobile robots may intersect at a given time, thereby causing the robots to dynamically generate new routes and therefore inhibiting the efficiency of the automated tasks performed by the mobile robots. These issues with the use of mobile robots in a manufacturing environment, among other issues with mobile robots, are addressed by the present disclosure.

### SUMMARY

This section provides a general summary of the disclosure and is not a comprehensive disclosure of its full scope or all of its features.

The present disclosure provides a method for defining a route of a first autonomous mobile robot (AMR) from among a plurality of AMRs in a manufacturing environment. The method includes identifying a set of intermediate grids of a grid map of the manufacturing environment based on a location of the first AMR and a destination grid of the grid map, where the set of intermediate grids and the destination grid indicate a traversable region of the manufacturing environment and has a predefined size, and the method includes appending temporal information to the set of intermediate grids based on a mobility characteristic of the first AMR, where the temporal information of the set of intermediate grids indicates a time of arrival for each intermediate grid from among the set of intermediate grids. The method includes generating a first reservation based on the set of intermediate grids and the temporal information of the set of intermediate grids, determining a state of the first reservation based on priority information associated with the plurality of AMRs and one or more additional reservations associated with the one or more additional AMRs from among the plurality of AMRs, and assigning the first reservation to the first AMR in response to the first reservation being in an available state.

In one form, the set of intermediate grids are identified based on a continuous path planning routine and a spatial buffer associated with the first AMR. In one form, the mobility characteristic is based on a velocity of the first AMR, a payload mass of the first AMR, or a combination thereof. In one form, the temporal information is further based on a communication offset time associated with the first AMR. In one form, the priority information is based on a payload type of the plurality of AMRs, a physical characteristic of the plurality of AMRs, or a combination thereof.

In one form, the method further includes determining the state of the first reservation is in an unavailable state in response to the one or more additional reservations including the set of intermediate grids. In one form, the method further includes determining the state of the first reservation is in an unavailable state in response to the temporal information of the set of intermediate grids of the first reservation corresponding to additional temporal information of the set of intermediate grids of the one or more additional reservations. In one form, the method further includes determining the state of the first reservation based on first priority information associated with the first AMR and additional priority information associated with the one or more additional AMRs, where the state of the first reservation is in the unavailable state in response to the first priority information indicating the first AMR has a lower priority than the one or more additional AMRs. In one form, the method further includes determining the state of the first reservation is in the available state in response to the one or more additional reservations not including the set of intermediate grids. In one form, the method further includes determining the state of the first reservation is in the available state in response to the one or more additional reservations including the set of intermediate grids and the temporal information of the set of intermediate grids of the first reservation not corresponding to additional temporal information of the set of intermediate grids of the one or more additional reservations. In one form, the method further includes determining the state of the first reservation based on first priority information associated with the first AMR and additional priority information associated with the one or more additional AMRs and determining the state of the first reservation is in the available state in response to the first priority information indicating the first AMR has a higher priority than the one or more additional AMRs. In one form, the method further includes removing an intermediate grid from the set of intermediate grids of the first reservation in response to the first reservation being in an unavailable state.

The present disclosure provides a system for defining a route of a first autonomous mobile robot (AMR) from among a plurality of AMRs in a manufacturing environment. The system includes a processor and a nontransitory computer-readable medium including instructions that are executable by the processor. The instructions include identifying a set of intermediate grids of a grid map of the manufacturing environment based on a location of the first AMR and a destination grid of the grid map, where the set of intermediate grids and the destination grid indicate a traversable region of the manufacturing environment and has a predefined size. The instructions include appending temporal information to the set of intermediate grids based on a mobility characteristic of the first AMR, where the temporal information of the set of intermediate grids indicates a time of arrival for each intermediate grid from among the set of intermediate grids, and where the mobility characteristic of the first AMR is based on a velocity of the first AMR, a payload mass of the first AMR, or a combination thereof. The instructions include generating a first reservation based on the set of intermediate grids and the temporal information of the set of intermediate grids and determining a state of the first reservation based on priority information associated with the plurality of AMRs and one or more additional reservations associated with the one or more additional AMRs from among the plurality of AMRs, where the priority information is based on a payload type of the plurality of AMRs, a physical characteristic of the plurality of AMRs, or a combination thereof. The instructions include assigning the first reservation to the first AMR in response to the first reservation being in an available state.

In one form, the instructions include determining the state of the first reservation is in an unavailable state in response to the one or more additional reservations including the set of intermediate grids. In one form, the instructions include determining the state of the first reservation is in an unavailable state in response to the temporal information of the set of intermediate grids of the first reservation corresponding to additional temporal information of the set of intermediate grids of the one or more additional reservations. In one form, the instructions include determining the state of the first reservation based on first priority information associated with the first AMR and additional priority information associated with the one or more additional AMRs, where the state of the first reservation is in the unavailable state in response to the first priority information indicating the first AMR has a lower priority than the one or more additional AMRs. In one form, the instructions include determining the state of the first reservation is in the available state in response to the one or more additional reservations not including the set of intermediate grids. In one form, the instructions include determining the state of the first reservation is in the available state in response to the one or more additional reservations including the set of intermediate grids and the temporal information of the set of intermediate grids of the first reservation not corresponding to additional temporal information of the set of intermediate grids of the one or more additional reservations. In one form, the instructions include determining the state of the first reservation based on first priority information associated with the first AMR and additional priority information associated with the one or more additional AMRs and determining the state of the first reservation is in the available state in response to the first priority information indicating the first AMR has a higher priority than the one or more additional AMRs. In one form, the instructions include removing an intermediate grid from the set of intermediate grids of the first reservation in response to the first reservation being in an unavailable state.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a manufacturing environment having a plurality of autonomous mobile robots and a reservation management system in accordance with the teachings of the present disclosure;

FIG. 2A illustrates a grid map and a route for the autonomous mobile robot based on its location and a destination within the manufacturing environment in accordance with the teachings of the present disclosure;

FIG. 2B illustrates a grid map and routes for additional autonomous mobile robots based on their respective locations and destinations within the manufacturing environment in accordance with the teachings of the present disclosure;

FIG. 2C illustrates a reservation of a route for an autonomous mobile robot in accordance with the teachings of the present disclosure;

FIG. 3A illustrates a reservation of a route for an autonomous mobile robot having modified temporal information in accordance with the teachings of the present disclosure;

FIG. 3B illustrates a grid map and a modified route for the autonomous mobile robot in accordance with the teachings of the present disclosure;

FIG. 3C illustrates a reservation of a modified route for an autonomous mobile robot in accordance with the teachings of the present disclosure; and

FIG. 4 is an example control routine for controlling a movement of the autonomous mobile robots in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides a reservation management system that controls the movement of a plurality of autonomous mobile robots of the manufacturing environment. Specifically, the reservation management system reserves a defined path for each of the autonomous mobile robots based on various parameters, such as continuous path planning routine, temporal information associated with various discretized locations of the defined path, and priority information associated with the autonomous mobile robots. Accordingly, the reservation management system enables autonomous mobile robots having different communication protocols, payloads, and mobility characteristics to autonomously navigate within the manufacturing environment such that path and temporal conflicts are inhibited.

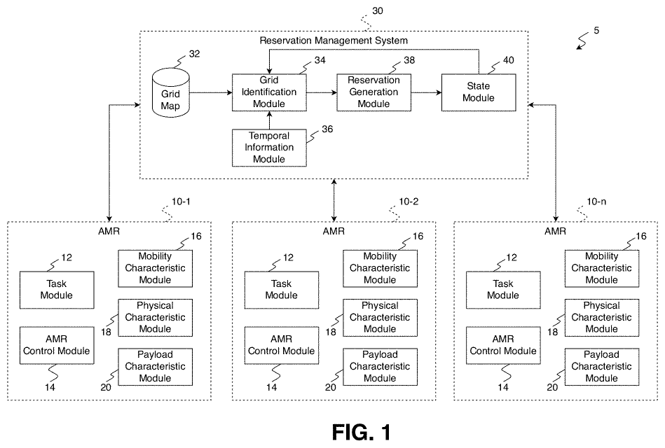

Referring to FIG. 1, a manufacturing environment 5 is provided and generally includes a plurality of autonomous mobile robots (AMRs) 10-1, 10-2, 10-n (collectively referred to hereinafter as “AMRs 10”) and a reservation management system (RMS) 30. It should be readily understood that any one of the components of the AMRs 10 and the RMS 30 can be provided at the same location or distributed at different locations (e.g., via one or more edge computing devices) and communicably coupled accordingly. In one form, the AMRs 10 and the RMS 30 are communicably coupled using a wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others).

In one form, the AMRs 10 are mobile robots that are partially or fully autonomous and are configured to autonomously move to various locations of the manufacturing environment 5 based on a reservation received from the RMS 30. To autonomously move itself, an AMR control module 14 is configured to control various movement systems of the AMR 10 (e.g., propulsion systems, steering systems, and/or brake systems) via actuators and based on one or more autonomous navigation sensors of the AMR 10 (e.g., a global navigation satellite system (GNSS) sensor, an imaging sensor, a local position sensor, among others). Furthermore, the AMR control module 14 is configured to operate the actuators to control the motion of one or more robotic links (e.g., robotic arms) attached thereto and thereby perform one or more automated tasks defined by a task module 12. The one or more automated tasks may refer to one or more motions the AMR 10 performs to achieve a desired result (e.g., removing a part from a bin, loading a workpiece into a fixture, transporting a payload from one location to another, among others).

In one form, the AMRs 10 include a mobility characteristic module 16, a physical characteristic module 18, and a payload characteristic module 20. In one form, the mobility characteristic module 16 is configured to broadcast a mobility characteristic of the AMRs 10 to the RMS 30. As used herein, “mobility characteristic” refers to any quantitative or qualitive mobility property of the AMR 10. Example mobility characteristics of the AMR 10 include, but are not limited to, a velocity (e.g., a current velocity or a maximum operating velocity), a payload mass (e.g., the impact of a given payload mass value with respect to the AMR velocity), and/or an AMR type (e.g., a walking AMR, a rolling AMR, a flying AMR, among other AMR types).

In one form, the physical characteristic module 18 is configured to broadcast a physical characteristic of the AMRs 10 to the RMS 30. As used herein, “physical characteristic” refers to any quantitative or qualitive physical property of the AMR 10. Example physical characteristics of the AMR 10 include, but are not limited to, a size, weight, and/or dimensions of the AMR 10. In one form, the payload characteristic module 20 is configured to broadcast a payload characteristic of the AMRs 10 to the RMS 30. As used herein, “payload characteristic” refers to any quantitative or qualitive property of the payload of the AMR 10. Example payload characteristics, but are not limited to, a payload type, size, weight, and/or dimensions of the payload of the AMR 10.

To perform the functionality described herein, the AMRs 10 may include one or more processor circuits that are configured to execute machine-readable instructions stored in one or more nontransitory computer-readable mediums, such as a random-access memory (RAM) circuit and/or read-only memory (ROM) circuit. The AMRs 10 may also include other components for performing the operations described herein, such as movement drivers and systems, transceivers, routers, and/or input/output interface hardware.

In one form, the RMS 30 includes a grid map 32, a grid identification module 34, a temporal information module 36, a reservation generation module 38, and a state module 40. In one form, the grid map 32 is a map of the manufacturing environment 5 that includes a plurality of grids defined by a plurality of intersecting horizontal and vertical lines. In one form, each grid represents a traversable region of the manufacturing environment 5 (e.g., a two-dimensional (2D) or three-dimensional (3D) region) and has a predefined size. In one form, each grid of the grid map 32 has the same size and shape, but it should be understood that the grids may have varying sizes and/or shapes in other forms.

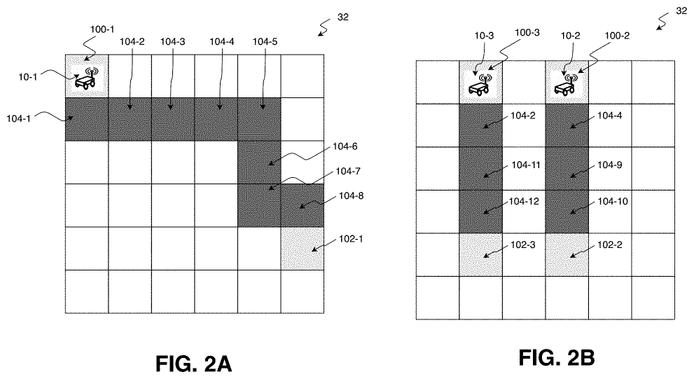

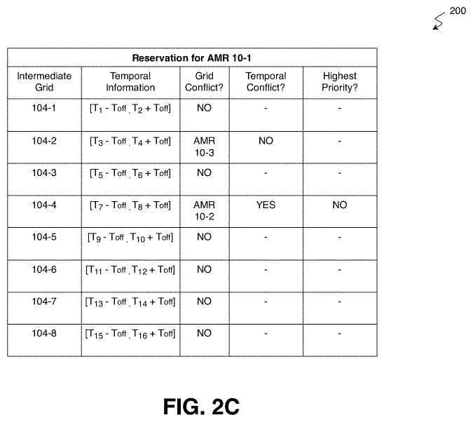

In one form, the grid identification module 34 is configured to identify a location of the AMRs 10 and a destination grid of the grid map 32 associated with each AMR 10. As an example and as shown in FIG. 2A, the grid identification module 34 determines that the AMR 10-1 is located at grid 100-1 based on the location data obtained via the AMR control module 14, and the grid identification module 34 identifies grid 102-1 as the destination grid based on task data and/or instructions obtained from the task module 12. As another example and as shown in FIG. 2B, the grid identification module 34 determines that the AMR 10-2 is located at grid 100-2 based on the location data obtained via the AMR control module 14, and the grid identification module 34 identifies grid 102-2 as the destination grid based on task data and/or instructions obtained from the task module 12. Furthermore and as shown in FIG. 2B, the grid identification module 34 determines that the AMR 10-3 is located at grid 100-3 based on the location data obtained via the AMR control module 14, and the grid identification module 34 identifies grid 102-3 as the destination grid based on task data and/or instructions obtained from the task module 12. While the location of the AMRs 10 is shown as being within the grid map 32, it should be understood that the location of the AMRs 10 may be outside of the grid map 32 in other forms.

In one form, the grid identification module 34 is configured to identify a set of intermediate grids of the grid map 32 based on a location of the AMRs 10 and the destination grid. In one form, the grid identification module 34 identifies the set of intermediate grids by using known path planning routines, such as a continuous path planning routine (e.g., a theta-star path planning routine, an a-star path planning routine, among others) or a discontinuous path planning routine.

In one form, the grid identification module 34 is configured to identify the set of intermediate grids based on a spatial buffer associated with the AMR 10. As used herein, “spatial buffer” refers to an area or region surrounding the AMR 10 in which the AMR 10 utilizes when performing an automated task and/or autonomously traversing the manufacturing environment 5 to satisfy various predefined performance and safety constraints. As an example, based on the size of the AMR 10, the spatial buffer of the AMRs 10 may cause the grid identification module 34 to identify one or more adjacent grids of the AMR 10 relative to a given grid when the AMR 10 is traversing through the given grid.

As an example and as shown in FIG. 2A, the grid identification module 34 identifies grids 104-1, 104-2, 104-3, 104-4, 104-5, 104-6, 104-7, 104-8 as the set of intermediate grids associated with the AMR 10-1 based on at least one of the continuous path planning routine and the spatial buffer associated with the AMR 10-1. As another example and as shown in FIG. 2B, the grid identification module 34 identifies grids 104-2, 104-11, 104-12 as the set of intermediate grids associated with the AMR 10-2 based one at least one of the continuous path planning routines and the spatial buffer associated with the AMR 10-2. Furthermore and as shown in FIG. 2B, the grid identification module 34 identifies grids 104-4, 104-9, 104-10 as the set of intermediate grids associated with the AMR 10-3 based one at least one of the continuous path planning routines and the spatial buffer associated with the AMR 10-3.

In one form, the temporal information module 36 is configured to append temporal information to the set of intermediate grids. In one form, the temporal information indicates, for each intermediate grid, a time of arrival of the AMR 10, a communication offset time associated with the AMR 10, or a combination thereof. As used herein, “communication offset time” refers to a communication delay between the AMRs 10 and the RMS 30 resulting from, for example, processing speeds of the AMR 10 and the RMS 30, delays associated with a given communication protocol, noise pollution of the manufacturing environment 5, among other factors that may cause a communication delay between the AMRs 10 and the RMS 30.

In one form, the temporal information module 36 is configured to append the temporal information to the set of intermediate grids based on the mobility characteristic as determined by the mobility characteristic module 16 (e.g., the velocity of the AMR 10, the payload mass of the AMR 10, and/or the type of AMR 10). As an example and as shown in table 200 of FIG. 2C, the temporal information module 36 appends a first discrete time value (T₁) and the communication offset time (T_{OFF}) to the intermediate grid 104-1 based on a time of arrival of the AMR 10-1 at the intermediate grid 104-1, which may be determined based on the location of the AMR 10-1 and the velocity of the AMR 10-1. Furthermore, the temporal information module 36 appends a second discrete time value (T₂) and the communication offset time (T_{OFF}) to the intermediate grid 104-1 based on a departure time of the AMR 10-1 from the intermediate grid 104-1, which may be determined based on the velocity of the AMR 10-1. Accordingly, the temporal information module 36 is configured to append a range of discrete times in which the AMR 10-1 will traverse through the intermediate grid 104-1 ([T₁−T_{OFF}, T₂+T_{OFF}]). The temporal information module 36 appends additional temporal information to the remaining set of intermediate grids associated with the AMR 10-1 (i.e., 104-2, 104-3, 104-4, 104-5, 104-6, 104-7, 104-8) and the set of intermediate grids associated with other AMRs 10 in a similar manner.

In one form, the reservation generation module 38 is configured to generate a reservation for each of the AMRs 10 based on the set of intermediate grids and the temporal information associated with the set of intermediate grids.

In one form, the state module 40 is configured to determine a state of the reservation of each of the AMRs 10. In one form, the state module 40 determines whether the reservation is in an available state or an unavailable state based on a comparison between the intermediate grids of a plurality of reservations, the temporal information of the plurality of reservations, the priority information of the AMRs 10, or a combination thereof. In one form, state module 40 determines the priority information based on a predefined control hierarchy and at least one of a payload type of the AMRs 10 as determined by the payload characteristic module 20 and a physical characteristic of the plurality of AMRs 10 as determined by the physical characteristic module 18.

In one form, a first reservation associated with the AMR 10-1 is in the unavailable state when one or more of the intermediate grids are also included as part of another reservation associated with another AMR 10. In another form, the first reservation associated with the AMR 10-1 is in the unavailable state when one or more of the intermediate grids are included as part of another reservation associated with another AMR 10 and have corresponding temporal information (i.e., the temporal information of the one or more shared intermediate grids have overlapping time ranges). In one form, the first reservation associated with the AMR 10-1 is in the unavailable state when one or more of the intermediate grids are included as part of a second reservation associated with the AMR 10-2, the one or more shared intermediate grids have corresponding temporal information, and the AMR 10-1 has a lower priority than the AMR 10-2 (e.g., the payload type of the AMR 10-2 has a type associated with a high priority value as determined by the predefined control hierarchy).

In one form, the first reservation associated with the AMR 10-1 is in the available state when the intermediate grids are not included as part of another reservation associated with one or more additional AMRs 10. In one form, the first reservation associated with the AMR 10-1 is in the available state when one or more of the intermediate grids are included as part of another reservation and do not have corresponding temporal information (i.e., the temporal information of the one or more shared intermediate grids do not have overlapping time ranges). In one form, the first reservation associated with the AMR 10-1 is in the available state when one or more of the intermediate grids are also included as part of a second reservation associated with the AMR 10-2, the one or more of the intermediate grids have corresponding temporal information, and the AMR 10-1 has a higher priority than the AMR 10-2 as determined by the predefined control hierarchy.

As an example and as shown in the table 200 of FIG. 2C, the state module 40 may determine that the intermediate grids 104-1, 104-3, 104-5, 104-6, 104-7, 104-8 of the first reservation associated with the AMR 10-1 do not have an intermediate grid conflict with any other reservations. Furthermore, the state module 40 may determine that while the intermediate grid 104-2 has a shared intermediate grid with a third reservation associated with the AMR 10-3, the temporal information associated with the intermediate grid 104-2 of the first and third reservations do not have overlapping time ranges. Additionally, the state module 40 may determine that the intermediate grid 104-4 has a shared intermediate grid with a second reservation associated with the AMR 10-2, the temporal information associated with the intermediate grid 104-4 of the first and second reservations have overlapping time ranges, and the AMR 10-1 has a lower priority than the AMR 10-1. As such, the state module 40 may determine that the first reservation associated with the AMR 10-1 is in the unavailable state based on the intermediate grid 104-4.

In one form, when the state module 40 determines that a reservation associated with an AMR is in the unavailable state, the state module 40 is configured to iteratively perform a corrective action to the reservation until it is in the available state. In one form, the corrective action includes instructing the grid identification module 34 to remove an intermediate grid from the set of intermediate grids and to add new grids to the set of intermediate grids based on the continuous path planning routine and/or instructing the temporal information module 36 to modify the temporal information of one or more grids from among the set of intermediate grids. In one form, the state module 40 is configured to perform the corrective action in response to the AMR 10 having a deviation in an expected or predetermined mobility characteristic that causes the arrival or departure time at one of the intermediate grids to deviate from the corresponding temporal information.

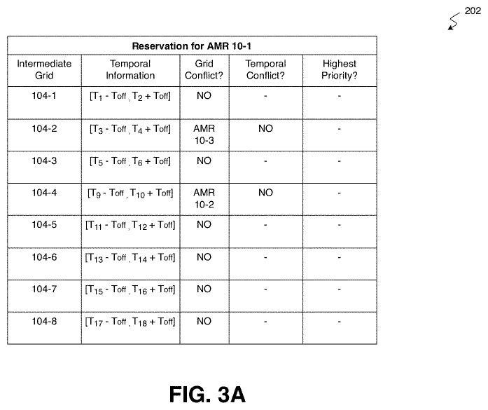

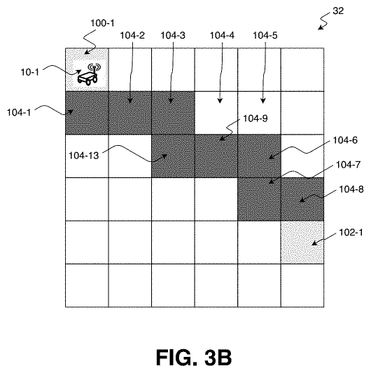

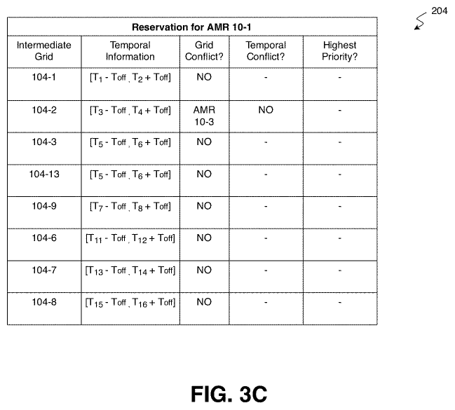

As an example and as shown in table 202 of FIG. 3A, the state module 40 may instruct the temporal information module 36 to modify the temporal information of the intermediate grid 104-4 such that the temporal information associated with the intermediate grid 104-4 of the first and second reservations do not have overlapping time ranges. Specifically, the temporal information module 36 may modify the temporal information from discrete time values ([T₇−T_{OFF}, T₈+T_{OFF}]) to new discrete time values ([T₉−T_{OFF}, T₁₀+T_{OFF}]) to avoid a temporal conflict between the first and second reservations. Accordingly, the AMR 10-1 may reduce its velocity at the preceding intermediate grid (i.e., intermediate grid 104-3) such that it arrives at the intermediate grid 104-4 at the new discrete time value (T₉) instead of the previously determined discrete time value (T₇).

As another example and as shown in FIG. 3B and table 204 of FIG. 3C, the state module 40 may instruct the grid identification module 34 to remove grids 104-4, 104-5 from the reservation and redefine the path based on the continuous path planning routine to the destination grid 102-1 such that grids 104-13, 104-9 are added to the reservation. Subsequently, the state module 40 determines the modified reservation is in the available state as a result of the intermediate grids 104-1, 104-3, 104-6, 104-7, 104-8, 104-9, 104-13 not being part of another reservation and the intermediate grid 104-4 not having a temporal conflict with the third reservation of the AMR 10-3.

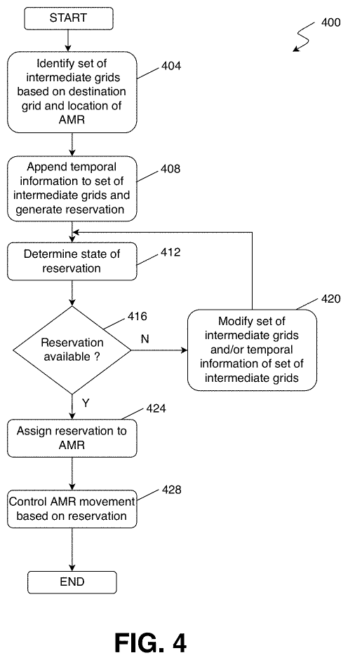

Referring to FIG. 4, a routine 400 for controlling a movement of the AMRs 10 is shown. At 404, the grid identification module 34 identifies a set of intermediate grids based on a destination grid and a location of the AMR 10. At 408, the temporal information module 36 appends temporal information to the set of intermediate grids, and the reservation generation module 38 generates the reservation based on the set of intermediate grids and the associated temporal information. At 412, the state module 40 determines the state of the reservation, and at 416, the state module 40 determines whether the reservation is in the available state. If the state module 40 determines the reservation is in the unavailable state, the routine 400 proceeds to 420, where the state module 40 instructs one of the grid identification module 34 to modify the set of intermediate grids and/or the temporal information module 36 to modify the temporal information of the set of intermediate grids and proceeds to 412. If the state module 40 determines the reservation is in the available state, the routine 400 proceeds to 424, where the state module 40 assigns and transmits the reservation to the AMR 10. At 428, the AMR control module 14 (or the RMS 30) controls the movement of the AMR 10 based on the reservation. Specifically, the AMR control module 14 dynamically controls the velocity of the AMR 10 such that the AMR 10 arrives and departs from the intermediate grids in accordance with the temporal information of the intermediate grids.

While routine 400 illustrates a routine for defining the path and temporal information of the AMR 10 prior to autonomously traveling to the destination grid, it should be understood that the routine 400 may be continuously performed while the AMR 10 autonomously travels to the destination grid to account for dynamic changes in the manufacturing environment 5. As an example, the RMS 30 and the AMR 10 may continuously perform the routine 400 to dynamically accommodate one or more unexpected obstacles provided at the intermediate grids of the reservation, an unexpected increase or decrease of the velocity of the AMR 10, or a combination thereof.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for defining a route of a first autonomous mobile robot (AMR) from among a plurality of AMRs in a manufacturing environment, the method comprising:
identifying a set of intermediate grids of a grid map of the manufacturing environment based on a location of the first AMR and a destination grid of the grid map, wherein the set of intermediate grids and the destination grid indicate a traversable region of the manufacturing environment and has a predefined size;
appending temporal information to the set of intermediate grids based on a mobility characteristic of the first AMR, wherein the temporal information of the set of intermediate grids indicates a time of arrival for each intermediate grid from among the set of intermediate grids;
generating a first reservation based on the set of intermediate grids and the temporal information of the set of intermediate grids;
determining a state of the first reservation based on priority information associated with the plurality of AMRs and one or more additional reservations associated with the one or more additional AMRs from among the plurality of AMRs; and
assigning the first reservation to the first AMR in response to the first reservation being in an available state.

2. The method of claim 1, wherein the set of intermediate grids are identified based on a continuous path planning routine and a spatial buffer associated with the first AMR.

3. The method of claim 1, wherein the mobility characteristic is based on a velocity of the first AMR, a payload mass of the first AMR, or a combination thereof.

4. The method of claim 1, wherein the temporal information is further based on a communication offset time associated with the first AMR.

5. The method of claim 1, wherein the priority information is based on a payload type of the plurality of AMRs, a physical characteristic of the plurality of AMRs, or a combination thereof.

6. The method of claim 1 further comprising determining the state of the first reservation is in an unavailable state in response to the one or more additional reservations including the set of intermediate grids.

7. The method of claim 6 further comprising determining the state of the first reservation is in an unavailable state in response to the temporal information of the set of intermediate grids of the first reservation corresponding to additional temporal information of the set of intermediate grids of the one or more additional reservations.

8. The method of claim 7 further comprising determining the state of the first reservation based on first priority information associated with the first AMR and additional priority information associated with the one or more additional AMRs, wherein the state of the first reservation is in the unavailable state in response to the first priority information indicating the first AMR has a lower priority than the one or more additional AMRs.

9. The method of claim 1 further comprising determining the state of the first reservation is in the available state in response to the one or more additional reservations not including the set of intermediate grids.

10. The method of claim 1 further comprising determining the state of the first reservation is in the available state in response to:
the one or more additional reservations including the set of intermediate grids; and
the temporal information of the set of intermediate grids of the first reservation not corresponding to additional temporal information of the set of intermediate grids of the one or more additional reservations.

11. The method of claim 10 further comprising:
determining the state of the first reservation based on first priority information associated with the first AMR and additional priority information associated with the one or more additional AMRs; and
determining the state of the first reservation is in the available state in response to the first priority information indicating the first AMR has a higher priority than the one or more additional AMRs.

12. The method of claim 1 further comprising removing an intermediate grid from the set of intermediate grids of the first reservation in response to the first reservation being in an unavailable state.

13. A system for defining a route of a first autonomous mobile robot (AMR) from among a plurality of AMRs in a manufacturing environment, the system comprising:
a processor; and
a nontransitory computer-readable medium including instructions that are executable by the processor, wherein the instructions include:
identifying a set of intermediate grids of a grid map of the manufacturing environment based on a location of the first AMR and a destination grid of the grid map, wherein the set of intermediate grids and the destination grid indicate a traversable region of the manufacturing environment and has a predefined size;
appending temporal information to the set of intermediate grids based on a mobility characteristic of the first AMR, wherein the temporal information of the set of intermediate grids indicates a time of arrival for each intermediate grid from among the set of intermediate grids, and wherein the mobility characteristic of the first AMR is based on a velocity of the first AMR, a payload mass of the first AMR, or a combination thereof;
generating a first reservation based on the set of intermediate grids and the temporal information of the set of intermediate grids;
determining a state of the first reservation based on priority information associated with the plurality of AMRs and one or more additional reservations associated with the one or more additional AMRs from among the plurality of AMRs, wherein the priority information is based on a payload type of the plurality of AMRs, a physical characteristic of the plurality of AMRs, or a combination thereof; and
assigning the first reservation to the first AMR in response to the first reservation being in an available state.

14. The system of claim 13, wherein the instructions further comprise determining the state of the first reservation is in an unavailable state in response to the one or more additional reservations including the set of intermediate grids.

15. The system of claim 14, wherein the instructions further comprise determining the state of the first reservation is in an unavailable state in response to the temporal information of the set of intermediate grids of the first reservation corresponding to additional temporal information of the set of intermediate grids of the one or more additional reservations.

16. The system of claim 15, wherein the instructions further comprise determining the state of the first reservation based on first priority information associated with the first AMR and additional priority information associated with the one or more additional AMRs, and wherein the state of the first reservation is in the unavailable state in response to the first priority information indicating the first AMR has a lower priority than the one or more additional AMRs.

17. The system of claim 13, wherein the instructions further comprise determining the state of the first reservation is in the available state in response to the one or more additional reservations not including the set of intermediate grids.

18. The system of claim 13, wherein the instructions further comprise determining the state of the first reservation is in the available state in response to:
the one or more additional reservations including the set of intermediate grids; and
the temporal information of the set of intermediate grids of the first reservation not corresponding to additional temporal information of the set of intermediate grids of the one or more additional reservations.

19. The system of claim 18, wherein the instructions further comprise:
determining the state of the first reservation based on first priority information associated with the first AMR and additional priority information associated with the one or more additional AMRs; and
determining the state of the first reservation is in the available state in response to the first priority information indicating the first AMR has a higher priority than the one or more additional AMRs.

20. The system of claim 13, wherein the instructions further comprise removing an intermediate grid from among the set of intermediate grids of the first reservation in response to the first reservation being in an unavailable state.
